(19) United States
(12) Patent Application Publication
(10) Pub. No.: US 2005/0199497 A1
(43) Pub. Date: Sep. 15, 2005

(54) Sensor for an electrochemical detecting element

(76) Inventor: Lothar Diehl, Gerlingen (DE)

Correspondence Address: KENYON & KENYON, ONE BROADWAY, NEW YORK, NY, 10004, US

(21) Appl. No.: 10/512,747

(22) PCT Filed: May 12, 2003
(86) PCT No.: PCT/DE03/01517

§ 371 Date: May 11, 2005

(30) Foreign Application Priority Data
May 14, 2002 (DE) 102 21 382.8

(51) Int. Cl. G01N 27/26; B05D 5/12

(52) U.S. Cl. 204/426; 427/123

(57) ABSTRACT

A sensor for an electrochemical measuring probe for determining the concentration of a gas component in a measuring gas, in particular for determining the oxygen concentration in the exhaust gas of internal combustion engines. The sensor includes a Nernst cell mounted on one side of a support on its surface, and an electric heater situated on the other side of the support. To avoid a bimetallic effect when the heater is rapidly heated up and the associated high tensile stresses in the longitudinal edges of the support, the heater is situated on a second support, which is attached to the first support, is made of the same material, and is at least approximately the same thickness as the first support.

### FIELD OF THE INVENTION

The present invention is directed to a sensor for an electrochemical measuring probe for determining the oxygen concentration in gases, in particular in the exhaust gas of internal combustion engines.

### BACKGROUND INFORMATION

In a conventional sensor of this type, as described in, e.g., German Patent Application No. DE 197 51 128, a heater designed as a wave-shaped electrical resistor is printed onto the surface of a support layer facing away from a Nernst cell and is covered by a likewise printed cover layer made of aluminum oxide (Al₂O₃). The cover layer and heater are co-fired jointly with the support layer. A porous adhesive layer is sintered onto the surface of the support layer receiving the Nernst cell, and a gas-tight base layer made of yttrium-stabilized zirconium oxide (ZrO₂) is printed onto the porous adhesive layer. The reference electrode and its lead, as well as a sacrificial layer providing the reference channel, are then printed in successive printing steps. Ion conductors, the solid electrolyte, and the external electrode with its lead are then printed on. An external porous protective layer is printed onto the external electrode and a gas-tight cover layer is printed onto the lead to the external electrode.

### SUMMARY

An example sensor according to the present invention may have the advantage that the heater is located in the middle of the sensor and generates a uniform low tensile stress on each side of the sensor. A bimetallic effect occurring in the conventional sensor when it is heated up rapidly and the resulting high tensile stresses in the longitudinal edges of the support are prevented. When only two ceramic foils are needed for the two supports, which may be made either of yttrium-stabilized zirconium oxide (ZrO₂) or of aluminum oxide (Al₂O₃), the layouts for both the heater and the Nernst cell may be manufactured geometrically completely independently of one another. Considerably less positional accuracy is needed in this case. The sensor has an excellent quick-start response, because only a low heat capacity must be heated up, and the central positioning of the heater allows high heat-up ramps. The example sensor design according to the present invention featuring two separate supports for the heater and the Nernst cell allows for a second measuring cell to be mounted on the surface of the second support facing away from the Nernst cell. This measuring cell may be either another Nernst cell or a cell having a different sensitivity, e.g., for hydrocarbons.

An example sensor according to the present invention may have the advantage that, due to the porous filling of the reference channel, the latter does not collapse when the sensor is pressed into a sensor housing, even in the case of a thin cover layer. Each electrode is provided in a simple manner with a double lead having a low ohmic resistance. The external electrode and reference electrode are only separated by a printed layer, namely the solid electrolyte, and have therefore nearly the same temperature. Due to the bottom lead insulation on the first support, which may also cover the area of the subsequently printed-on reference channel, the Nernst cell may be insulated against interference from the heater. In this case, the first support is in contact with the material of the probe housing.

An example method according to the present invention for manufacturing the above-described sensor may have the advantage that it is simple and cost-effective to carry out and permits the manufacture of a sensor having a low installation height.

### BRIEF DESCRIPTION OF THE DRAWINGS

The present invention is explained in detail with reference to the exemplary embodiments illustrated in the figures and the description below.

FIG. 1 schematically shows a cross section of a sensor for an electrochemical measuring probe near its measuring gas side end according to section line I-I in FIG. 4.

FIG. 2 schematically shows a cross-section of the sensor near its end away from the measuring gas according to section line II-II in FIG. 4.

FIG. 3 schematically shows a top view of the individual functional layers of the sensor illustrated in FIG. 1, without the heater.

FIG. 4 schematically shows a top view of the four successive bottom layers illustrated in FIG. 3.

FIG. 5 schematically shows an illustration of a modified sensor similar to FIG. 1.

### DESCRIPTION OF EXEMPLARY EMBODIMENTS

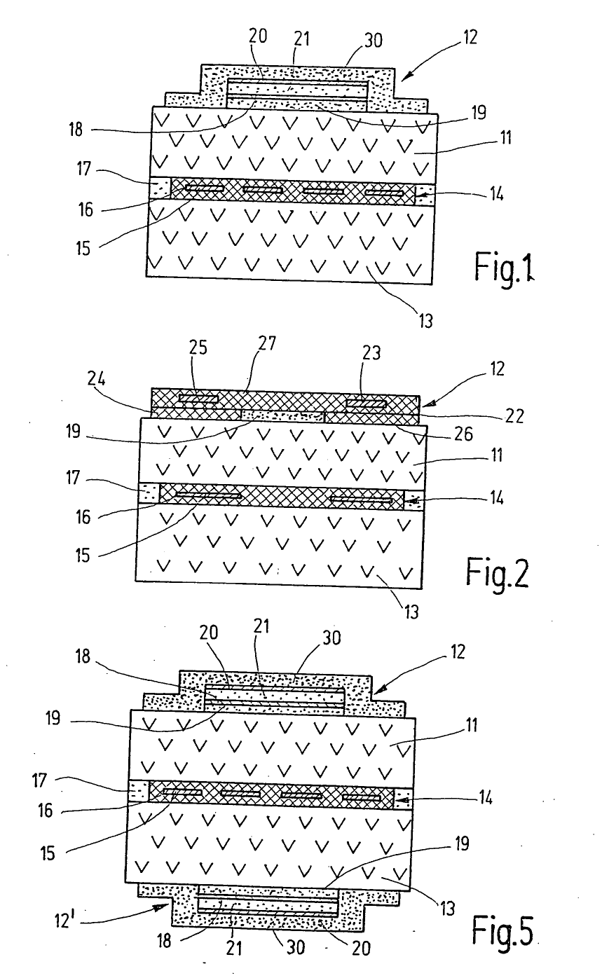

In accordance with an example embodiment of the present invention, the sensor for an electrochemical measuring probe for determining the oxygen concentration in the exhaust gas of internal combustion engines, illustrated in FIGS. 1 and 2 in two different section views, also known as planar lambda-1 probe or planar Sprung probe, has a first support 11 made of yttrium-stabilized zirconium oxide (ZrO₂), on which a Nernst cell 12 is mounted, and a second support 13 made of yttrium-stabilized zirconium oxide, on which an electric heater 14 is mounted. The two supports 11, 13 have the same thickness.

Heater 14 includes a wave-shaped flat resistor 15, which is embedded in an aluminum oxide (Al₂O₃) insulator 16 and is connectable to a heating voltage. Resistor 15 and insulator 16 are printed, for example, on the surface of second support 13. Insulator 16 is advantageously enclosed by a sealing frame 17 made of a solid electrolyte 21. First support 11 is permanently bonded to insulator 16, e.g., via an insulating and non-ion-conducting foil binder. Alternatively, both supports 11, 13 may be made of aluminum oxide (Al₂O₃). This does not require an insulator 16, and the aluminum oxide sealing frame encloses resistor 15.

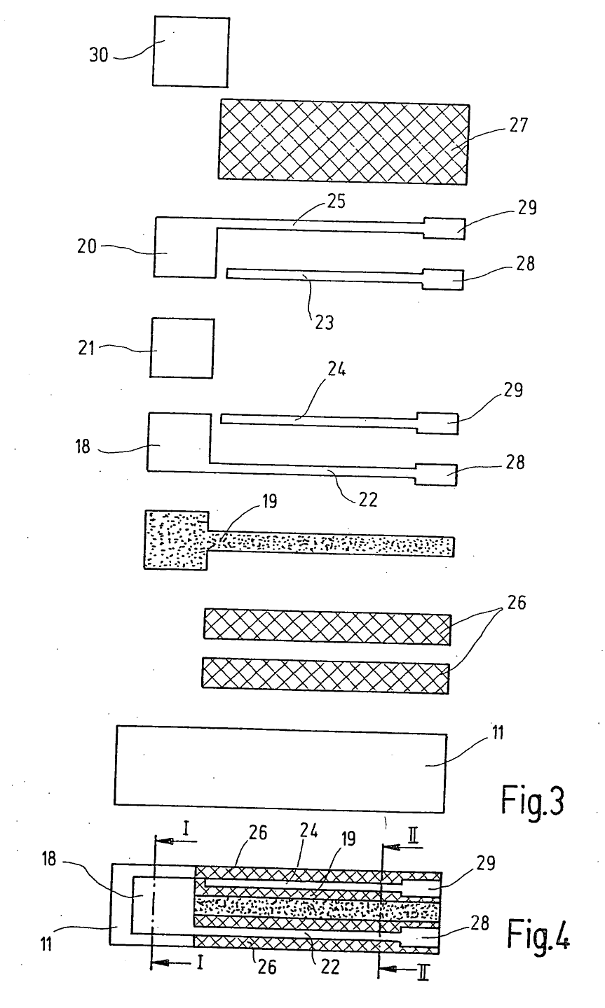

Nernst cell 12 has a reference electrode 18 on the measuring gas side end of support 11, which is exposed to a reference gas, normally air, via a reference gas channel 19, and an external electrode 20 exposed to the measuring gas, i.e., the exhaust gas. Reference electrode 18 and external electrode 20 are situated on either side of solid electrolyte 21 facing away from one another and are provided with electrical leads formed by flat conductor tracks. Reference gas channel 19 is porously filled with aluminum oxide, for example, and runs in the middle between two pairs of leads lying directly on top of one another. One pair made up of a first lead 22 and second lead 23 belongs to reference electrode 18, and one pair made up of a first lead 24 and a second lead 25 belongs to external electrode 20. First lead 22 of reference electrode 18 and first lead 24 of external electrode 20 are situated in the plane of reference electrode 18, first lead 22 being connected to reference electrode 18 to form a single piece. Second lead 23 of reference electrode 18 and second lead 25 of external electrode 20 are in the plane of external electrode 20, second lead 25 being connected to external electrode 20 to form a single piece. Each pair of leads 22, 23 and 24, 25, respectively, is covered by a bottom insulation layer 26 and a top insulation layer 27, bottom insulation layer 26 being situated directly on the surface of first support 11 and being cut out in the area of reference gas channel 19, while top insulation layer 27 covers second leads 22, 23 and reference gas channel 19 between them. Leads 22, 23 and 24, 25, respectively, which lie directly on top of one another in each pair, form, at the end of first support layer 11 away from the measuring gas, terminal contacts 28, 29 having a larger cross section. As FIG. 2 shows, reference electrode 18 formed on the measuring gas side end of the sensor lies directly on top of filled porous reference gas channel 19. Solid electrolyte 21 is situated between reference electrode 18 and external electrode 20, and external electrode 20 is covered by a gas-permeable protective layer 30. FIG. 3 shows a top view of the above-described individual functional layers of Nernst cell 12. These functional layers are situated on top of one another starting with first support 11. Support 11 is—like support 13—designed as a ceramic foil, onto which the other functional layers are printed.

The sensor thus described is manufactured as follows, reference being made to FIG. 3 and the reference numerals provided there:

Bottom insulation layer 26, 27 is printed onto support foil 11, it being cut out in the area of reference gas channel 19. Alternatively, insulation layer 26 may also cover the area of reference gas channel 19. Filled, porous reference gas channel 19 is subsequently printed, it being preferably manufactured of open porous aluminum oxide (Al₂O₃) . Reference electrode 18, its first lead 22, and second lead 23 are printed for external electrode 20 as the next functional layer, and end contacts 28, 29 are formed. Solid electrolyte 21 made of yttrium oxide-stabilized (Y₂O₃) zirconium oxide (ZrO₂) is then printed in several thin printed layers. External electrode 20 and its second lead 25, which is congruent to first lead 24, follows, and at the same time second lead 23 for reference electrode 18, which is congruent to first lead 22, is also printed. Top insulation layer 27, which covers second leads 23, 25 and reference gas channel 19, is subsequently printed. The open porous aluminum oxide of reference gas channel 19 ensures optimum connection to above-lying insulation layer 27, which has closed pores and is also made of aluminum oxide. Finally, gas-permeable protective layer 30 is printed onto external electrode 20.

FIG. 4 shows how bottom functional layers 11, 26, 19, and 18 together with 22 and 24 in FIG. 3 are situated on top of one another. The remaining four functional layers 20 including 25, and 23, 27, and 30 in FIG. 3 are printed on top of one another in the geometry shown, resulting in the sensor illustrated as a cross section in FIGS. 1 and 2. The individual functional layers are preferably printed using the screen printing method.

The described design of the sensor in FIGS. 1 and 2 having heater 14 situated in the middle of the sensor permits a second Nernst cell 12′ to be mounted on the surface of second support 13 facing away from first support 11, as FIG. 5 shows as a cross section. The design of Nernst cell 12′ corresponds to that of previously described Nernst cell 12, so that the same components are provided with the same reference numerals. Instead of a Nernst cell 12′, a cell having a different sensitivity, for example for hydrocarbons, may also be provided.

1-13. (canceled)

14. A sensor for an electrochemical measuring probe for determining a concentration of a gas component in a measuring gas, comprising:
a first support;
a Nernst cell mounted on a surface of one side of the first support, the Nernst cell including a reference electrode exposed to a reference gas, an external electrode exposed to a measuring gas, and an ion-conducting solid electrolyte separating the reference electrode from the external electrode;
an electric heater situated on another side of the first support; and
a second support affixed to the first support, the heater being attached to the second support, the second support being made of a same material as the first support and having at least approximately a same thickness as the first support.

15. The sensor as recited in claim 14, wherein the sensor is for determining an oxygen concentration in exhaust gas of an internal combustion engine.

16. The sensor as recited in claim 14, wherein the first support and the second support are made of yttrium oxide-stabilized (Y₂O₃) zirconium oxide (ZrO₂), and wherein the heater is embedded in an insulator.

17. The sensor as recited in claim 14, wherein the first support and the second support are made of aluminum oxide (Al₂O₃).

18. The sensor as recited in claim 14, further comprising:
one of a second Nernst cell or a measuring cell having a different measuring sensitivity, the one of the Nernst cell or the measuring cell being mounted on a surface of the second support facing away from the heater.

19. The sensor as recited in claim 18, wherein the measuring cell is configured to meausre hydrocarbon.

20. The sensor as recited in claim 14, wherein the first support and the second support are foils.

21. The sensor as recited in claim 14, wherein the reference electrode is situated in a porously filled reference channel, which runs between two pairs of leads lying on top of one another, of which one pair of the leads belongs to the reference electrode and one pair of the leads belongs to the external electrode, a bottom lead of each pair of leads is in one plane with the reference electrode and a top lead is in one plane with the external electrode, and each pair of leads is covered by a bottom and a top insulation layer.

22. The sensor as recited in claim 21, wherein the external electrode is covered by a gas-permeable, porous protective layer.

23. The sensor as recited in claim 22, wherein the protective layer is made of aluminum oxide.

24. The sensor as recited in claim 21, wherein the reference channel is made of porous aluminum oxide.

25. The sensor as recited in claim 21, wherein the leads are flat conductor tracks.

26. The sensor as recited in claim 21, wherein individual layers, electrodes, and leads are printed one on top of the other on the first support.

27. A method for manufacturing a sensor, comprising:
printing a bottom insulation layer onto a first support;
subsequently printing a porously filled reference gas channel onto the first support in a middle of an insulation layer and protruding beyond a bottom insulation layer on a measuring gas side end;
subsequently printing a reference electrode and a first lead of the reference electrode and a first lead of an external electrode in such a way that the reference electrode covers a measuring gas side front section of the reference gas channel and the first lead of the reference electrode and the first lead of the external electrode rest on the bottom insulation layer;
printing a solid electrolyte in an area of the reference electrode in several thin printed layers;
printing in a joint printing operation, the external electrode onto the solid electrolyte, a second lead of the external electrode onto the first lead of the external electrode, and a second lead of the reference electrode onto the first lead of the reference electrode;
printing a top insulation layer on the first and second leads of the external electrode and the reference gas channel between them; and
printing a protective layer on the external electrode.

28. The method as recited in claim 27, wherein printing is performed using a screen printing method.
